(19) United States
(12) Patent Application Publication
(10) Pub. No.: US 2024/0383231 A1
(43) Pub. Date: Nov. 21, 2024

(54) LAMINATED GLAZING

(71) Applicant: AGC GLASS EUROPE, Louvain-la-Neuve (BE)

(72) Inventors: Nicolas OU, Gosselies (BE); Anne-Christine BAUDOUIN, Corbais (BE); Kadosa HEVESI, Namur (BE)

(73) Assignee: AGC GLASS EUROPE, Louvain-la-Neuve (BE)

(21) Appl. No.: 18/687,047

(22) PCT Filed: Sep. 26, 2022
(86) PCT No.: PCT/EP2022/076625

§ 371 Date: Feb. 27, 2024

(30) Foreign Application Priority Data
Sep. 30, 2021 (EP) 21200198.6

(51) Int. Cl. B32B 17/10; B05D 1/00

(52) U.S. Cl. CPC B32B 17/10036; B05D 1/60; B32B 17/10201; B32B 17/1055; B32B 2250/05; B32B 2250/40; B32B 2255/10; B32B 2272/00; B32B 2398/20

(57) ABSTRACT

A laminated glazing, including a first pane having an inner and an outer surface, a second pane having an inner and an outer surface, and a thermoplastic interlayer. The thermoplastic interlayer connects the inner surface of the first pane to the inner surface of the second pane, the thermoplastic interlayer is formed from at least one thermoplastic film layer containing at least 10% of recycled material, and at least one of the inner surface of the first pane or the inner surface of the second pane is provided with a functional coating including a topcoat layer based on a mixed nitride of silicon and zirconium.

### FIELD OF THE INVENTION

The present invention relates to laminated glazing, and more specifically to laminated

glazing comprising a thermoplastic film layer comprising at least 10% of recycled material.

### BACKGROUND OF THE INVENTION

Typically, a laminated glazing is provided with at least 2 panes, adhered together by means of a thermoplastic interlayer. The advantage of such a glass is that it does not shatter into lose pieces upon breakage, but remains bonded to the thermoplastic interlayer in case of damage. Laminated glazing may typically be used in transportation applications or architectural applications, where glass breakage is to be avoided and/or for sound attenuation.

Various types of thermoplastic interlayers may be used, such as polyvinyl butyral (PVB) or ethylene-vinyl acetate (EVA) which may have some sound insulation properties. In some instances, combinations of different types of the thermoplastic interlayer materials may be used to obtain specific properties.

Recycled thermoplastic materials may be obtained by the reprocessing of used materials and/or of left-overs of fresh thermoplastic materials, obtained after cutting and sizing for example. Disassembly and recovery of individual components of laminated glazing are known since the early 1990's. While recycling composite materials was not considered seriously in the past, the situation today has changed, in view of the growing concern for environmental issues associated with industrial applications.

Continuous improvements in the re-use of waste materials has thus led to the development of recycled thermoplastic materials used in the field of laminated glazing.

For example, DE202020102125U1 discloses a laminated glazing where a non-recycled PVB sheet and a recycled PVB sheet are arranged side-by-side so as to bond two glass sheets. However there is no mention of coatings on the glass sheets.

Despite technological efforts in the field of the recycling of thermoplastic materials, some recycled materials fail to exhibit the exact same properties as the original materials, also named “virgin” or “fresh” materials. Recycled PVB, for example, may experience more shrinkage than a “virgin” PVB and its yellowness may be more pronounced.

This was found to be problematic in particular for laminated coated glass, in particular bearing magnetron sputtered coatings, where adhesion properties and resistance to breakage were found to suffer from quality losses. While minor losses in quality of the recycled materials may be accepted, minor losses in safety may not be tolerated.

Coated glass substrates are well known in the field of laminated glazing. The coatings may provide for solar control, heat control or other functionalities. Such coated glass substrates may be used in laminated form, using thermoplastic materials. With the rise of the recycled thermoplastic materials, it actually appeared that some of these materials failed to exhibit consistent quality in the adhesion with coated glass substrates. Therefore, it was observed that not all coatings can be used in direct contact with a thermoplastic interlayer comprising recycled material. This may be a problem in automated production lines, in case a change of a component ultimately might lead to failure of the final product. This problem did not occur when using “virgin” PVB with standard coatings developed to date. This risk in production can not be tolerated.

Therefore, there is found a need to provide for a coated substrate with compatibility with thermoplastic film layers comprising at least 10% of recycled material.

The applicant has discovered, surprisingly, that the use of a topcoat layer based on a mixed nitride of silicon and zirconium, as upper protective layer of a magnetron sputtered functional coating, makes it possible to considerably improve the compatibility and adhesion to a thermoplastic film layers comprising at least 10% of recycled material, while retaining a good resistance to the high-temperature heat treatment and a good chemical and mechanical resistance.

### SUMMARY OF THE INVENTION

The present invention therefore provides for a laminated glazing comprising a first pane having an inner and an outer surface, a second pane having an inner and an outer surface and a thermoplastic interlayer, which connects the inner surface of the first pane to the inner surface of the second pane,
a. wherein the thermoplastic interlayer is formed from at least one thermoplastic film layer comprising at least 10% of recycled material, and
b. wherein at least one of the inner surface of the first pane or the inner surface of the second pane is provided with a functional coating comprising a topcoat layer based on a mixed nitride of silicon and zirconium.

For the purpose of the present invention the term ‘inner surface’ designates a surface of a glass pane facing the thermoplastic interlayer it is bonded to and the term ‘outer surface’ designates a surface of a glass pane opposite the ‘inner surface’.

The present invention also provides for a method to provide for a laminated glazing comprising the steps of:
a. providing for a first pane having an inner and an outer surface, and for a second pane having an inner and an outer surface;
b. providing for a functional coating comprising a topcoat layer based on a mixed nitride of silicon and zirconium on one of the inner surface of the first pane or the inner surface of the second pane;
c. providing for a thermoplastic interlayer formed from at least one thermoplastic film layer comprising at least 10% of recycled material;
d. assembling the inner surface of the first pane to the inner surface of the second pane by means of the thermoplastic interlayer to form the laminated glazing.

The present invention last provides for the use of a topcoat layer comprising a mixed nitride of silicon and zirconium on a functional coating, to secure adhesion with a thermoplastic film layer comprising at least 10% of recycled material in a laminated glazing.

### DETAILED DESCRIPTION OF THE INVENTION

The laminated glazing of the present invention comprises a first pane having an inner and an outer surface, a second pane having an inner and an outer surface and a thermoplastic interlayer, which connects the inner surface of the first pane to the inner surface of the second pane,
a. wherein the thermoplastic interlayer is formed from at least one thermoplastic film layer comprising at least 10% of recycled material, and
b. wherein at least one of the inner surface of the first pane or the inner surface of the second pane is provided with a functional coating comprising a topcoat layer based on a mixed nitride of silicon and zirconium.

The first and second panes may be a glass sheet, or a plastic sheet comprising or consisting of poly(methyl meth)acrylate (PMMA), polycarbonates, polyethyleneterephthalate (PET), polyolefins, polyvinyl chloride (PVC), or mixtures thereof. Transparency of a substrate is considered when light transmission (T) is superior to 10%, alternatively superior to 20%, alternatively superior to 30%.

In most instances, at least one of the first and second panes is a glass substrate. It is however preferred that the first and second panes both be glass substrates.

The glass may be of any type, such as conventional float glass or flat glass, and may be of any composition having any optical properties, e.g., any value of visible transmission above 10%, ultraviolet transmission, infrared transmission, and/or total solar energy transmission.

The glass may be a soda-lime, a borosilicate, a leaded glass, or an alumino-silicate glass. The glass may be regular a clear, colored or extra-clear (i.e. lower Fe content and higher transmittance) glass substrate. Further examples of glass substrates include clear, green, bronze, or blue-green glass substrates.

The glass may be annealed, tempered or heat strengthened glass.

The first and second panes may independently have a thickness ranging from 0.5 mm to about 15 mm, alternatively from 0.5 mm to about 10 mm, alternatively from 0.5 mm to about 8 mm, alternatively from 0.5 mm to about 6 mm.

The first and second panes in the present laminated glazing may have a thickness ranging from 0.5 to 3 mm.

Both panes may have the same thickness, for example 0.5 mm, or 0.8 mm, or 1.2 mm, or 1.6 mm, or 2.1 mm, or 3 mm. Such symmetrical construction in glass thickness allows for ease of process and conventional sizing of the laminating process.

Both panes may also have different thicknesses, providing for asymmetrical laminated glazings, for example pane 1=0.5 mm and pane 2=2.1 mm, or pane 1=0.8 mm and pane 2=2.1 mm, or pane 1=0.5 mm and pane 2=1.6 mm, pane 1=0.8 mm and pane 2=1.6 mm, or pane 1=1.6 mm and pane 2=2.1 mm. Such asymmetrical constructions in glass thickness allow for flexibility in curvature, and/or in weight management and/or flexibility in light/solar modulation.

In the scope of the present invention, the thermoplastic interlayer is formed from at least one thermoplastic film layer comprising at least 10% of recycled material, alternatively at least 20% of recycled material, alternatively at least 60% of recycled material, alternatively 100% of recycled material. Typically, the remainder of the thermoplastic interlayer may be formed of virgin material; which may be the same type or a different from the at least one thermoplastic film layer comprising at least 10% of recycled material.

In the scope of the present invention, the recycled material of the at least one thermoplastic film layer may encompass recovered material from remainders of a lamination process, waste rolls, or surplus materials. That is, thermoplastic film layers that have been processed within a lamination step, and are cut off from final laminates, may be recovered and gathered to be mixed and reprocessed to furnish recycled material. Such recycled material typically is the result of a mixture of various sources of initial material, such that chemical composition is more varied than for “fresh” or “virgin” thermoplastic film layer. Indeed, “fresh” or “virgin” thermoplastic materials will typically have a reproducible and calibrated composition, consistent and constant over time, as the result of specific chemical compositions and the presence of specific ions will thus be defined by their origin and supplier. The thermoplastic materials typically contain metal salts or preferable alkali metallic salt or even more preferably alkaline-earth metal salt, typically used as adhesive force regulating agents to keep an adequate adhesion between glass and “fresh” thermoplastic film and so to ensure adhesion of the material to glass panes.

For example, “fresh” thermoplastic material (PVB) from one PVB sheet manufacturing company may be characterized by the presence of Mg and Na ions, or by the presence of Mg and K ions; while a “fresh” thermoplastic material (PVB) from another PVB sheet manufacturing company may be characterized by the presence of K and S ions, in addition to Mg and Na ions.

On the other hand, recycled materials will typically contain waste of various initial fresh thermoplastic materials from different commercial sources and thus different compositions, such that their combination after recycling will have fluctuating composition, from one batch to another, and will contain a broader variety of ions than the original and fresh thermoplastic materials, as being the result of a mixture of different sources.

The recycled material useful in the present invention may typically be characterized by a composition comprising a wide and fluctuant variety of ions, comprising at least the ions of Mg, Na, K, S, P, Li, Rb, Cs, Ca, Sr and Ba. These ions are thus the residuals of the mixtures of the metal salts retrieved from the original “fresh” or “virgin” thermoplastic film layer after the recycling procedure.

Without wishing to be bound by theory, the inventors have found that the topcoat comprising SiZrN is less sensitive to the presence of said fluctuating mixtures of ions and to the respective amounts of said ions, in the at least one thermoplastic film layer comprising at least 10% of recycled material.

In some instances, the thermoplastic interlayer is formed only of thermoplastic film layers comprising at least 10% of recycled material, which may have the same or different compositions.

In other instances, the thermoplastic interlayer is a thermoplastic film layer comprising at least 10% of recycled material, alternatively at least 20% of recycled material, alternatively at least 60% of recycled material, alternatively 100% of recycled material. The topcoat layer based on a mixed nitride of silicon and zirconium is particularly effective at ensuring adhesion to a thermoplastic film layer made of 100% recycled material by its superior compatibility to such materials.

The terms “polymer interlayer sheet,” “interlayer,” “interlayer” as used herein, generally may designate a single-layer sheet or a multilayered interlayer. A “single-layer sheet,” as the names implies, is a single or monolithic thermoplastic layer extruded as one layer which is then used to laminate two panes. A multilayered interlayer, on the other hand, may comprise multiple layers, including separately extruded layers, co-extruded layers, or any combination of separately and co-extruded layers of thermoplastic material. Thus a multilayered interlayer could comprise, for example: two or more single-layer sheets combined together (“plural-layer sheet”); two or more layers co-extruded together (“co-extruded sheet”); two or more co-extruded sheets combined together; a combination of at least one single-layer sheet and at least one co-extruded sheet; a combination of at least one plural-layer sheet and at least one co-extruded sheet, or any other combination of sheets as desired.

Typical materials for the thermoplastic film layer include, but are not limited to, polyvinyl acetal, polyvinyl butyral, polyurethane, poly(ethylene-co-vinyl acetate), polyvinylchloride, poly(vinylchloride-co-methacrylate), polyethylenes, polyolefins, ethylene acrylate ester copolymers, poly(ethylene-co-butyl acrylate), silicone elastomers, epoxy resins, and acid copolymers.

Preferably, the at least one thermoplastic film layer comprising at least 10% of recycled material comprises a material selected from the group consisting of ethylene vinyl acetate and/or polyvinyl butyral and/or polyethyleneterephthalate. The topcoat layer based on a mixed nitride of silicon and zirconium is compatible with materials which are thus available in “fresh” and/or in recycled form.

In some embodiments, the thermoplastic film layer comprising at least 10% of recycled material is a polyvinyl butyral film layer.

The thermoplastic film layer may be a transparent or translucent polymer interlayer. However, for decorative applications, the thermoplastic film layer may be colored or patterned. In some instances, the thermoplastic film layer may comprise photophores, heat insulating particles, infrared absorbing particles, polymer-dispersed liquid crystals, or suspended particles (SPD).

The thermoplastic interlayer may thus comprise more than one thermoplastic film layer, wherein at least one comprises at least 10% of recycled material. That is, thermoplastic film layers of PVB (polyvinyl butyral), or EVA (ethylene-vinyl acetate) or PET (polyethyleneterephthalate) may be used in conjunction, provided at least one comprises at least 10% of recycled material. This may be useful in instances where a PET film is provided with an infrared reflective coating, and requires to be inserted within the thermoplastic interlayer.

The thermoplastic film layer comprising at least 10% of recycled material may be obtained by methods known in the art, and which are not the subject of the present invention. The recycling process of the thermoplastic material typically occurs through shredding, crushing and washing, with solvents and or water, for separation of the glass and thermoplastic material, then separation of said material from other chemicals present (stabilizers, plasticizers, dyes, etc.), followed by extraction and/or filtration. The thermoplastic material obtained may then be used again using an alcoholic process for example. Various methods exist, which lead to materials having chemical and physical properties similar or equal to standard (fresh/virgin) material. It is upon use, that characterization of dissimilarities appear, with modified compatibilities with typical stacks of thin layers. Due to the different shades of thermoplastic waste material, a decoloring step may be included, or pigments or dyes added to the recycled material to neutralize the shade of the recycled material.

Although thermoplastic film layers comprising at least 10% of recycled material are designed to have similar properties to standard/fresh materials, experience has shown that thermoplastic film layers comprising at least 10% of recycled material may have varying ions concentration from one batch to another, as discussed above. Without wishing to be bound by theory, it is believed that such varying chemical composition may be the root cause of the varying adhesion performance to the panes, for example of glass, specifically when said pane is coated with a functional coating. A lower adhesion performance may ultimately lead to a lower impact resistance, as demonstrated by poor resistance to perforation (big ball drop test).

Such a problem occurred upon the increasing use of new types of recycled thermoplastic materials.

The thermoplastic film layer comprising at least 10% of recycled material typically has a molecular weight of greater than 50,000 Daltons, or less than 500,000 Daltons, or about 50,000 to about 500,000 Daltons, or about 70,000 to about 500,000 Daltons, or more preferably about 100,000 to about 425,000 Daltons, as measured by size exclusion chromatography using low angle laser light scattering. As used herein, the term “molecular weight” means the weight average molecular weight.

The thermoplastic film layer comprising at least 10% of recycled material typically has a glass transition temperature (Tg) of from 0° C. to 45° C.

The thermoplastic film layer comprising at least 10% of recycled material typically has a yellowness <5.0%.

The thermoplastic film layer comprising at least 10% of recycled material typically has a shrinkage <5.0%.

The thickness of the thermoplastic film layer comprising at least 10% of recycled material may be in a range from 0.25 mm to 2.54 mm, from 0.25 mm to 2.29 mm, from 38 mm to 1.52 mm, from 0.51 to 1.27 mm, or from 0.38 to 0.89 mm.

Examples of thermoplastic film layer of polyvinylbutyral comprising at least 10% of recycled material include Trosifol® from Kuraray Corp., Butacite®G from Dupont, Butvar or Saflex® from Eastman, or products from Sekisui Corp.

The topcoat layer based on a mixed nitride of silicon and zirconium thereby allows the use of either standard thermoplastic film layer or thermoplastic film layer comprising at least 10% of recycled material. Some typical topcoats were found to be poorly compatible with thermoplastic film layer comprising at least 10% of recycled material, leading to more breakage and cohesive failure.

In the scope of the present invention, the at least one thermoplastic film layer comprising at least 10% of recycled material is in contact with the topcoat layer based on a mixed nitride of silicon and zirconium of the functional coating.

In the scope of the present invention, the term “functional coating” refers to a coating which modifies one or more physical properties of the substrate, e.g., optical, thermal, chemical or mechanical properties. Such a functional coating is not intended to be removed from the substrate during subsequent processing. The functional coating is typically a permanent or “non-removable” coating.

The functional coating may be a solar control coating, a conductive coating, an antireflective coating, a reflective coating, a decorative coating and/or a low emissivity coating.

The functional coating may be a single layer or a stack of thin layers, that is, a multiple layer coating, and the layers may include one or more metals, non-metals, semi-metals, semiconductors, or alloys, compounds, composites, combinations, or blends thereof.

When discussing a functional coating in the present invention, it is typically understood that the layers are numbered in sequence starting from the substrate surface. That is, a first layer is understood to be the first applied on the substrate, a second being the second layer applied on the substrate, above the first layer. The successive order of the positions is considered relative to the substrate onwards, up to the uppermost layer.

In the scope of the present invention, the terms “below”, “underneath”, “under” indicate the relative position of a layer vis a vis a next layer, within the layer sequence starting from the substrate. In the scope of the present invention, the terms “above”, “upper” indicate the relative position of a layer vis a vis a next layer, within the layer sequence starting from the substrate.

In the scope of the present invention, the relative positions of the layers within the stack do not necessarily imply direct contact between the layers. That is, some interlayer may be provided between the first and second layer. For example, a first layer “deposited over” the substrate does not preclude the presence of one or more other coating layers of the same or different composition located between that first layer film and the substrate, provided the objective of the present invention is not jeopardized.

In some instances, a layer may actually be composed of several multiple individual layers.

The functional coating may have a thickness ranging from 10 to 1000 nm.

Unless stated otherwise, all layer thicknesses herein are geometrical layer thicknesses.

In certain embodiments of the invention, the functional coating may be a solar control coating, where the solar control coating includes visible, infrared and/or ultraviolet energy reflecting or absorbing coatings and is used to avoid overheating of buildings or vehicles.

In certain embodiments of the invention, the functional coating may be an electrically conductive coating such as an electrically conductive heated window coating or a single-film or multi-film coating capable of functioning as an antenna.

A functional coating may be a low emissivity coating typically allowing visible wavelengths, e.g., from about 400 nm to about 780 nm, to be transmitted through the coating but reflecting maybe some shorter-wavelength solar infrared energy and mostly longer wavelength thermal infrared energy, typically intended to improve the thermal insulating properties of architectural glazings. By “low emissivity” is meant emissivity less than about 0.3, alternatively less than about 0.2.

The functional coating may be a single layer metal oxide coating, a multiple layer metal oxide coating, a non-metal oxide coating, or a multiple layer coating.

In certain embodiments of the invention, single layer metal oxide coatings include those coatings comprising a zinc oxide doped with aluminum, gallium or hafnium; a mixed oxide of zinc and tin; tin oxide possibly doped with fluor or antimony; indium oxide possibly doped with tin; or the like.

Examples of multiple layer coatings include dielectric coatings comprising multiple layers of dielectric materials. Dielectric materials include metal oxides, nitrides, carbides, oxynitrides, oxycarbides, oxycarbonitrides, and the like. Dielectric coatings may include those coatings comprising multiple layers of dielectric materials having alternating refractive indices, that is, coatings comprising at least one layer of high refractive index material, and at least one layer of low refractive index material. Such coatings are typically represented with a coating comprising a first layer of material having a low or high refractive index, a second layer of material having a high or low refractive index, a third layer of material having a low or high refractive index, a fourth layer of material having a high or low refractive index, and optional protective layer. A low refractive index is typically a refractive index <1.8, or typically <1.7, while a high refractive index is typically a refractive index >1.8, or typically >1.9 or >2.0. Some layers may have intermediate refractive indices comprised of from 1.7 to <1.9. Refractive indices are typically considered at a wavelength of 550 nm. Such coatings may be designed for antireflection purposes or for reflection purposes, based on the use of the Fresnel reflections put in place, as dielectric highly reflective coatings reflect light based on constructive interference to maximize Fresnel reflections, while the antireflective coatings will utilize destructive interference to minimize Fresnel reflections.

In some instances, the present laminated glazing may comprise a functional coating comprising n infrared reflective (IR) layers and n+1 dielectric layers, with n≥1, such that each IR layer is surrounded by two dielectric layers.

That is, the laminated glazing may comprise a first pane having an inner and an outer surface, a second pane having an inner and an outer surface and a thermoplastic interlayer, which connects the inner surface of the first pane to the inner surface of the second pane,
a. wherein the thermoplastic interlayer is formed from at least one thermoplastic film layer comprising at least 10% of recycled material, and
b. wherein at least one of the inner surface of the first pane or the inner surface of the second pane is provided with a functional coating comprising n infrared reflective (IR) layers and n+1 dielectric layers, with n≥1, such that each IR layer is surrounded by two dielectric layers, and comprising a topcoat layer based on a mixed nitride of silicon and zirconium.

A topcoat layer is typically understood as the topmost layer in the layer stack, furthest away from the substrate surface. That is, the topcoat layer based on a mixed nitride of silicon and zirconium is in contact with the at least one thermoplastic film layer comprising at least 10% of recycled material of the thermoplastic interlayer, when used in the present laminated glazing.

When there is only one IR functional layers (when n=1), the first dielectric layer may be referred to as the first or lower dielectric layer, in contact with the surface of the pane on which it is deposited, and the second dielectric layer may be referred to as the last or upper dielectric layer, in contact with air.

When there are two IR functional layers (when n=2), the second dielectric layer may be referred to as the “internal dielectric layer”, as it is sandwiched between two IR functional layers.

When there are three or more IR functional layers (when n=3 or more), the second and third (and further) dielectric layers may be referred to as “internal dielectric layers”, as they are respectively sandwiched between two IR functional layers. The last dielectric layer is then that above the last IR functional layer.

The IR layers may be made of silver, gold, palladium, platinum or alloys thereof. The IR layer or functional layer may have a thickness from 2 to 30 nm, alternatively from 5 to 20 nm, alternatively from 7 to 18 nm. These thickness ranges may enable the desired low emissivity and/or solar control function and/or conductivity to be achieved while retaining a good light transmission.

The dielectric layers may typically comprise oxides, nitrides, oxynitrides or oxycarbides of Zn, Sn, Ti, Zr, Si, In, Al, Bi, Ta, Hf, Mg, Nb, Y, Ga, Sb, Mg, Cu, Ni, Cr, Fe, V, B or mixtures thereof.

In certain embodiments of the present invention, the dielectric layers may comprise oxides, nitrides, oxynitrides or oxycarbides of Zn, Sn, Ti, Zr, Si, In, Al, Nb, Sb, Ni, Cr, V, Mb, Mg or mixtures thereof. Alternatively, the dielectric layers may comprise oxides, nitrides, oxynitrides of Zn, Sn, Ti, Zr, Si, In, Al, Nb, Sb, Ni, Cr, or mixtures thereof.

These materials may optionally be doped, where examples of dopants include aluminum, zirconium, or mixtures thereof. The dopant or mixture of dopants may be present in an amount up to 15 wt %.

Typical examples of dielectric materials include, but are not limited to, silicon based oxides, silicon based nitrides, zinc oxides, aluminum doped zinc oxides, zinc-based oxides, tin oxides, mixed zinc-tin oxides, silicon nitrides, silicon oxynitrides, titanium oxides, aluminum oxides, zirconium oxides, niobium oxides, aluminum nitrides, bismuth oxides, mixed silicon-zirconium nitrides, and mixtures of at least two thereof, such as for example titanium-zirconium oxides, titanium-niobium oxides, zinc-titanium oxides, zinc-gallium oxides, zinc-indium-gallium oxides (IGZO), zinc-titanium-aluminum oxides (ZTAO), zinc-tin-titanium oxides, zinc-aluminum-vanadium oxides, zinc-aluminum-molybdenum oxides, zinc-aluminum-magnesium oxides, zinc-aluminum-chromium oxides, zinc-aluminum-copper oxides, zinc-titanium-zirconium oxides.

The dielectric layer may consist of a plurality of individual layers comprising or essentially consisting of the above materials.

The dielectric layers may each have a thickness ranging from 0.1 to 200 nm, alternatively from 0.1 to 150 nm, alternatively from 1 to 120 nm, alternatively from 1 to 80 nm. Different dielectric layers may have different thicknesses. That is, the first dielectric layer may have a thickness that is the same or different, greater or smaller, compared to the thickness of the second or third or any other dielectric layer.

The functional coating may comprise a seed layer underneath at least one IR layer, and/or the coating may comprise a barrier layer on at least one IR layer. A seed layer is typically provided to assist in forming a good quality film of the IR material, that is, providing for a homogeneous and stable layer of IR material. A barrier layer is typically provided to assist in protecting the IR material from degradation induced by the formation of any layer above it, for example to protect it from oxygen or oxygenated species which may deteriorate the quality of the IR layer and also from deterioration due to heat treatments.

A given IR layer may be provided with either a seed layer, or a barrier layer or both. A first IR layer may be provided with either one or both of seed and barrier layers, and a second IR layer may be provided with either one or both of seed and barrier layers and further so. These constructions are not mutually exclusive. The seed and/or barrier layers may have a thickness from 0.1 to 35 nm, alternatively 0.5 to 25 nm, alternatively 0.5 to 15 nm, alternatively 0.5 to 10 nm.

The functional coating may also comprise a thin layer of sacrificial material having a thickness <15 nm, alternatively <9 nm, alternatively <5 nm, said thickness being at least 0.2 nm, provided above and in contact with at least one functional layer. Examples of sacrificial material include titanium, zinc, nickel, chromium, niobium, tantalum, oxides of Ni, oxides of Ni alloys, oxides of Cr, oxides of Cr alloys, NiCrOₓ, NiCrOₓN_{y}, zinc oxide, tin oxide, or other suitable material or mixture thereof.

A dielectric layer may be provided with an absorbing layer adjusted in order to selectively alter transmission of the coated article. In certain examples, the thickness of said absorbing layer can be adjusted to significantly adjust the transmission of the coated article without adversely affecting coloration thereof. Examples of absorbing layer include Ni, Cr, NiCr, NiCrNₓ, NiCrW, CrN, ZrN, TiN, Ti, Zr, NiOₓ, or the like. Such an absorption layer may located such that at least one of the IR layer is located over the absorption layer, optionally, such an absorbing layer may be sandwiched between and contacting a first and a second layer comprising silicon nitride. The absorbing layer may have a thickness ranging from 0.5 to 10 nm.

A first example of functional coating serving as a low emissivity coating comprises at least one silver layer, and a sequence: substrate/MeO/ZnO:AlSi/Ag/AlSi—MeO where MeO is a metallic oxide such as SnO₂, TiO₂, In₂O₃, Bi₂O₃, ZrO₂, Ta₂O₅, SiO₂ or Al₂O₃ or a mixture thereof.

A second example of functional coating serving as low emissivity coating, includes a first dielectric layer including silicon nitride; first Ni or NiCr inclusive layer; an infrared (IR) reflecting layer comprising silver; a second Ni or NiCr inclusive layer; and a second dielectric layer including silicon nitride.

A third example of functional coating comprises
* an infrared (IR) reflecting layer contacting and sandwiched between first and second layers, said second layer comprising NiCrOₓ; and
* wherein at least said second layer comprising NiCrOₓ is oxidation-graded so that a first portion of said second layer close to said infrared (IR) reflecting layer is less oxidized than a second portion of said second layer that is further from said infrared (IR) reflecting layer.

A fourth example of functional coating comprises: a dielectric layer; a first layer comprising zinc oxide located over the dielectric layer; an infrared (IR) reflecting layer comprising silver located over and contacting the first layer comprising zinc oxide; a layer comprising an oxide of NiCr located over and contacting the IR reflecting layer; a second layer comprising zinc oxide located over and contacting the layer comprising the oxide of NiCr; and another dielectric layer located over the second layer comprising zinc oxide.

A fifth example of functional coating comprises: a first dielectric layer; a first infrared (IR) reflecting layer comprising silver located over at least the first dielectric layer; a first layer comprising zinc oxide located over at least the first IR reflecting layer and the first dielectric layer; a second IR reflecting layer comprising silver located over and contacting the first layer comprising zinc oxide; a layer comprising an oxide of NiCr located over and contacting the second IR reflecting layer; a second layer comprising zinc oxide located over and contacting the layer comprising the oxide of NiCr; and another dielectric layer located over at least the second layer; comprising zinc oxide.

A sixth example of functional coating comprises: a first dielectric layer; a first layer comprising zinc oxide located over the dielectric layer; an infrared (IR) reflecting layer comprising silver located over and contacting the first layer comprising zinc oxide; a second layer comprising zinc oxide located over the IR layer; and a second dielectric layer located over the second layer comprising zinc oxide. The first and second dielectric layers may comprise several layers, among which layers of varying composition in zinc oxide, that is, layers of zinc oxide, zinc oxide doped with aluminum, or layers of mixed oxide of zinc and tin, having a ratio Sn/Zn ranging from 0.5 to 2 by weight, or having a ratio Sn/Zn ranging from 0.02 to 0.5 by weight; layers of silicon nitride; layers of titanium oxide; among others. The first and second layers comprising zinc oxide may also have varying composition in zinc oxide, that is, layers of zinc oxide; zinc oxide doped with aluminum; mixed oxide of zinc and tin; mixed oxide of zinc, titanium and aluminum; among others.

A seventh example of functional coating comprises, in sequence: a first dielectric layer; a first IR layer comprising silver; a second dielectric layer; a second IR layer; a third dielectric layer. The first, second and third dielectric layers may comprise several layers, among which layers of varying composition in zinc oxide, that is, layers of zinc oxide, zinc oxide doped with aluminum, or layers of mixed oxide of zinc and tin, having a ratio Sn/Zn ranging from 0.5 to 2 by weight, or having a ratio Sn/Zn ranging from 0.02 to 0.5 by weight; layers of mixed oxide of zinc, titanium and aluminum; layers of silicon nitride; layers of titanium oxide; among others. In some instances, the IR layers may be independently provided with a metallic barrier layer such as Ti, Ni, NiCr, or the like.

An eight example of functional coating comprises, in sequence: a first dielectric layer; a first IR layer comprising silver; a second dielectric layer; a second IR layer; a third dielectric layer; a third IR layer; a fourth dielectric layer. The first, second, third and fourth dielectric layers may comprise several layers, among which layers of varying composition in zinc oxide, that is, layers of zinc oxide, zinc oxide doped with aluminum, or layers of mixed oxide of zinc and tin, having a ratio Sn/Zn ranging from 0.5 to 2 by weight, or having a ratio Sn/Zn ranging from 0.02 to 0.5 by weight; layers of mixed oxide of zinc, titanium and aluminum; layers of silicon nitride; layers of titanium oxide; among others. In some instances, the IR layers may be independently provided with a metallic barrier layer such as Ti, Ni, NiCr, or the like.

A wide variety of functional coatings may be provided with the topcoat layer based on a mixed nitride of silicon and zirconium, benefitting from the topcoat providing for compatibility with the thermoplastic film layer comprising at least 10% of recycled material.

Mixed nitrides of silicon and zirconium are known in the field of functional coatings. It is however surprisingly found that this material in particular, provides for improved compatibility with thermoplastic film layers comprising at least 10% of recycled material.

As discussed above, the rising use of thermoplastic film layers comprising at least 10% of recycled material with coated glass has shown some compatibility issues which do not occur with “virgin” thermoplastic materials. The present topcoat layer may be used independently with thermoplastic material containing recycled matter or which do not contain recycled matter.

The topcoat is understood to be in an upper position relative to the functional coating provided on the inner surface of at least one of the first or second pane. That is, the present topcoat is situated the furthest away from the pane relative to the first deposition surface of said pane, typically in contact with air.

The topcoat layer based on a mixed nitride of silicon and zirconium may have a thickness ranging of from 0.5 to 22 nm, alternatively of 1 to 20 nm, alternatively of from 2 to 19 nm. A preferred range of thickness of the topcoat may be 5 to 18 nm. At such a thickness of the topcoat, an optimal compromise is made between the durability of the un-laminated coating or glazing and its compatibility with thermoplastic film layers comprising at least 10% of recycled material.

The topcoat is the uppermost layer above the functional coating, in direct contact with the last layer of said functional coating. In some instances, the last layer of the functional coating does not specifically provide for mechanical and/or chemical durability. In such instances, the present topcoat provides for mechanical and chemical durability of the functional coating, together with providing for improved compatibility with thermoplastic film layers comprising at least 10% of recycled material.

In some instances, the topcoat may be deposited on and in contact with a layer comprising at least one of silicon nitride, aluminum nitride, mixed nitride of silicon and aluminum, titanium oxide, zirconium oxide, mixed oxide of titanium and zirconium, silicon oxide, aluminum oxide, zinc oxide, tin oxide, mixed oxide of zinc and tin, or a mixture thereof.

The functional coating may thus initially comprise a last layer providing for some mechanical and/or chemical durability, such as layers of titanium oxide, zirconium oxide, mixed oxide of titanium and zirconium, with 45-65% wt Ti; or silicon oxide, aluminum oxide; or oxide of zirconium and aluminum. In such instances, the present topcoat provides for improved compatibility with thermoplastic film layers comprising at least 10% of recycled material and potentially for even superior mechanical and chemical durability of the functional coating, particularly in view of abrasion.

The last layer of the functional coating may also be a layer comprising at least one of silicon nitride or aluminum nitride, or a mixture thereof. Such a layer may have a thickness have a thickness ranging of from 2 to 50 nm, alternatively of from 2 to 40 nm, alternatively of from 2 to 35 nm. This has the particular effect of improving the stack cohesion (or cohesive strength) while ensuring improved compatibility with thermoplastic film layers comprising at least 10% of recycled material. Without wishing to be bound by theory, the layer of silicon nitride or aluminum nitride, or a mixture thereof under and in contact with the present topcoat is believed to provide for a gradient of composition such that adhesion between the functional coating and the topcoat is improved.

The topcoat layer based on a mixed nitride of silicon and zirconium may have a minimum atomic Si/Zr ratio of 3.2, or 4.0, or 4.5, or 5.5. The topcoat layer based on a mixed nitride of silicon and zirconium may have a maximum atomic Si/Zr ratio of 12.0, or 10.0, or 9.0, or 8.0, or 6.5.

The topcoat layer may be characterized with a refractive index ranging of from 1.7 to 2.6, alternatively of from 1.9 to 2.5.

In particular circumstances, the range of Si/Zr atomic ratio of from 5.5 to 12 was found to combine both the improved compatibility with thermoplastic materials comprising at least 10% recycled material, but also to provide for mechanical and chemical resistance of the pane prior to lamination. There is typically a better compatibility when there is more Si than Zr in the mixed nitride in terms of atomic percent, as compared to prior art topcoats having more Zr than Si in a layer of zirconium silicon nitride.

The topcoat layer based on a mixed nitride of silicon and zirconium may contain oxygen in an amount of from 0 to 10 atomic %, or of from 0.5 to 10 atomic %, or of from 0.5 to 5 atomic %.

The presence of oxygen may be tolerated, provided the function of the topcoat is not jeopardized, with regard to the compatibility with the thermoplastic film layers comprising at least 10% of recycled material.

In an embodiment compatible with the other embodiments above, the present invention also provides for a laminated glazing comprising a first pane having an inner and an outer surface, a second pane having an inner and an outer surface and a thermoplastic interlayer, which connects the inner surface of the first pane to the inner surface of the second pane,
wherein the thermoplastic interlayer is formed from at least one thermoplastic film layer comprising at least 10% of recycled material, and
wherein at least one of the inner surface of the first pane or the inner surface of the second pane is provided with a functional coating comprising a topcoat layer based on a mixed nitride of silicon and zirconium having a Si/Zr ratio of from 5.5 to 12.

That is, the present invention also provides for a laminated glazing comprising a first pane having an inner and an outer surface, a second pane having an inner and an outer surface and a thermoplastic interlayer, which connects the inner surface of the first pane to the inner surface of the second pane,
a. wherein the thermoplastic interlayer is formed from at least one thermoplastic film layer comprising at least 10% of recycled material, and
b. wherein at least one of the inner surface of the first pane or the inner surface of the second pane is provided with a functional coating comprising n infrared reflective (IR) layers and n+1 dielectric layers, with n≥1, such that each IR layer is surrounded by two dielectric layers, and comprising a topcoat layer based on a mixed nitride of silicon and zirconium having a Si/Zr ratio of from 5.5 to 12.

Also provided herein is a process to provide for a laminated glazing comprising the steps of:
a. providing for a first pane having an inner and an outer surface, and for a second pane having an inner and an outer surface;
b. providing for a functional coating comprising a topcoat layer based on a mixed nitride of silicon and zirconium on one of the inner surface of the first pane or the inner surface of the second pane;
c. providing for a thermoplastic interlayer formed from at least one thermoplastic film layer comprising at least 10% of recycled material;
d. laminating the inner surface of the first pane to the inner surface of the second pane by means of the thermoplastic interlayer to form the laminated glazing.

The outer and inner panes may be any of the substrates discussed above. They may be the same or different, according to the intended use of the laminated glazing composed therewith. They may have the same thickness or different thicknesses, as discussed above.

The functional coating may be provided by various vacuum deposition methods, including magnetron sputtering, LPCVD (low pressure chemical vapor deposition), plasma enhanced chemical vapor deposition PECVD. Individual layers of the same stack may be provided by different deposition methods.

A preferred method however includes magnetron sputtering, for both the functional coating and the topcoat.

The parameters include Power (P) in kW, current (I) in amps, and pressure (Press.) in mbar. The gas flow may be adapted to the layer to be provided, with gases such as argon, oxygen, nitrogen or mixtures thereof.

The topcoat may preferably be provided from a metallic target based on Si and Zr comprising 50 to 80 wt % Si and 20 to 50wt % Zr, to provide for the atomic ratio of Si/Zr as discussed above, in a nitrogen comprising atmosphere, or in a nitrogen/argon atmosphere, optionally with limited oxygen flow such as to reach a level of oxygen as discussed above.

The metallic target based on Si and Zr may thus comprise 50 wt % Si, alternatively 60 wt % Si, alternatively 65 wt % Si, alternatively 75 wt % Si, alternatively 80 Si wt % Si.

The metallic target based on Si and Zr may thus comprise 20 wt % Zr, alternatively 25 wt % Zr, alternatively 35 wt % Zr, alternatively 40 wt % Zr, alternatively 50 wt % Zr.

The first and/or second pane may undergo a heat treatment, prior or after the deposition of the functional coating and topcoat.

While at least one of the inner surface of the first or second pane is provided with the functional coating and topcoat, any of the other surfaces may actually also be provided with a different or the same functional coating, with or without the present topcoat. That is, the laminated glazing may be provided with at least two functional coatings, which may be the same or different and which may each be provided with the topcoat based on a mixed nitride of silicon and zirconium.

The heat treatment process may involve heating or exposing the pane provided with the coating to a temperature greater than about 560° C., for example, between 560° C. and 700° C. in the atmosphere. Other heat treatment processes may be sintering of a ceramic or enamel material, vacuum sealing of a double glazing unit and calcination of a wet-coated low reflective coating or anti-glare coating.

The heat treatment process, especially when this is a bending and/or thermal tempering and/or thermal hardening operation, may be carried out at a temperature of at least, 600° C. for at least 10 minutes, 12 minutes, or 15 minutes, at least 620° C. for at least 10 minutes, 12 minutes, or 15 minutes, or at least 640° C. for at least 10 minutes, 12 minutes, or 15 minutes.

The laminating step may be provided by a typical glass lamination processes either by use of calander (nip-roll) or by use of vacuum bag/ring. A first process comprises the following steps: (1) assembly of the two panes and interlayer; (2) heating the assembly via an IR radiant or convective means for a short period; (3) passing the assembly into a pressure nip roll for the first deairing; (4) heating the assembly a second time to about 60° C. to about 120° C. to give the assembly enough temporary adhesion to seal the edge of the interlayer; (5) passing the assembly into a second pressure nip roll to further seal the edge of the interlayer and allow further handling; and (6) autoclaving the assembly at temperatures between 110° C. and 150° C. and pressures ranging from 10 to 15 Bar for a period of 10 to 120 minutes. A vacuum bag/ring process comprises (1) assembly of the two panes and interlayer; (2) applying a vacuum between 1-500 mbar for 5-30 minutes (3) heating the assembly via an IR radiant or convective means for a short period while keeping the vacuum (4) cooling down and releasing the vacuum (5) autoclaving the assembly at temperatures between 110° C. and 150° C. and pressures ranging from 10 to 15 Bar for a period of 10 to 120 minutes.

The laminated glazing obtained herein is useful for transportation applications or architectural applications, or wherever a laminated glazing may find uses. It may be designed for aesthetics, if colored or textured; for safety; for acoustic comfort. Transportation applications include windshields, roofs, cockpits, sidelights, backlights, among others. Architectural applications include curtain walls, windows, doors, shop displays, fridge doors, and the like.

The laminated glass according to the invention fulfills the high safety requirements in the vehicle sector. These requirements are typically checked by standardized fracture, impact and scratch tests, such as the ECE R43 ball drop test, well known to the skilled person.

The laminated glass according to the invention further fulfills the requirements of mechanical resistance in the pummel tests, also well known to the skilled person, thanks to the adhesion and strength provided by the topcoat layer to the functional coating.

The present topcoat layer in contact with the thermoplastic film layer comprising at least 10% of recycled material of the laminated glazing thus provides for a high level of adhesion between the two glass panes and the thermoplastic interlayer, such that the laminated glazing has a high impact resistance (big ball drop test).

The adhesion of the sheets of a laminated glazing to the laminated layer is typically assessed by means of the pummel test giving a pummel value of between 0 (non-adherence) to 10 (complete adherence in the test). A pummel value of between 3 and 7 is usually required for the outer pane of a laminated windscreen for automotive use. A weak zone may have a pummel value of less than or equal to 3, and preferably less than or equal to 2, with respect to at least one of the panes.

The present laminated glazing displays mechanical resistance in the pummel tests, thanks to the adhesion and cohesive strength provided by the topcoat layer to the functional coating, such that no adhesive failure occurs in the laminated glazing. Indeed, adhesion was found secured by the presence of the topcoat layer comprising a mixed nitride of silicon and zirconium on a functional coating.

The present invention last relates to the use of a topcoat layer comprising a mixed nitride of silicon and zirconium on a functional coating, to secure adhesion with a thermoplastic film layer comprising at least 10% of recycled material in a laminated glazing.

In preferred uses, the functional coating may comprise n infrared reflective (IR) layers and n+1 dielectric layers, with n≥1, such that each IR layer is surrounded by two dielectric layers.

In most preferred uses, the topcoat may be deposited on and in contact with a layer comprising at least one of silicon nitride, aluminum nitride, mixed nitride of silicon and aluminum, titanium oxide, zirconium oxide, mixed oxide of titanium and zirconium, silicon oxide, aluminum oxide, zinc oxide, tin oxide, mixed oxide of zinc and tin, or a mixture thereof.

A last advantage is that the topcoat also provides good chemical and mechanical resistance before the lamination step can occur, such that the coated pane does not get damaged during storage, processing, or shipping.

Therefore, in specific instances, compatible with the above, the present invention may provide for a glazing comprising a transparent substrate coated with a functional coating further comprising a topcoat layer based on a mixed nitride of silicon and zirconium having a Si/Zr ratio of from 5.5 to 12.

Indeed, when the glazing is not provided within a laminated glazing, and the pane consists in a glass sheet, the present topcoat, specifically when having a Si/Zr atomic ratio of from 5.5 to 12 was found to provide for improved mechanical and chemical durability of the functional coating, particularly in view of abrasion, but also with compatibility with the glues and sealants used in the manufacture of insulated glass units, such as double glazing or triple glazing or vacuum insulated glass units. Indeed, in some circumstances, the sealants ensuring adhesion of the insulated glass may show lack of adhesion to coated panes, and as such, tightness of the insulated glass unit may not be ensured. The present topcoat allows for improved compatibility with such sealants, such that edge deletion is not necessary.

The topcoat layer present on the glazing may have a total geometrical thickness of from 0.5 to 22 nm.

This is particularly the case, when the functional coating comprises n infrared reflective (IR) layers and n+1 dielectric layers, with n≥1, such that each IR layer is surrounded by two dielectric layers.

In such glazing, the topcoat may be deposited on and in contact with a layer comprising at least one of silicon nitride, aluminum nitride, mixed nitride of silicon and aluminum, titanium oxide, zirconium oxide, mixed oxide of titanium and zirconium, silicon oxide, aluminum oxide, zinc oxide, tin oxide, mixed oxide of zinc and tin, or a mixture thereof.

The invention is further described in the following numbered clauses.

Clause 1: A laminated glazing comprising a first pane having an inner and an outer surface, a second pane having an inner and an outer surface and a thermoplastic interlayer, which connects the inner surface of the first pane to the inner surface of the second pane,
a. wherein the thermoplastic interlayer is formed from at least one thermoplastic film layer comprising at least 10% of recycled material, and
b. wherein at least one of the inner surface of the first pane or the inner surface of the second pane is provided with a functional coating comprising a topcoat layer based on a mixed nitride of silicon and zirconium.

Clause 2: Laminated glazing according to clause 1, wherein the at least one thermoplastic film layer comprises at least 20% of recycled material, or at least 60% of recycled material, or 100% of recycled material.

Clause 3: Laminated glazing according to clause 1, wherein the thermoplastic interlayer is a thermoplastic film layer comprising at least 10% of recycled material.

Clause 4: Laminated glazing according to clause 1 or 3, wherein the thermoplastic interlayer is a thermoplastic film layer comprising at least 20% of recycled material, or at least 60% of recycled material, or 100% of recycled material.

Clause 5: Laminated glazing according to any one of the preceding clauses, wherein the at least one thermoplastic film layer is selected from polyvinyl acetal, polyvinyl butyral, polyurethane, poly(ethylene-co-vinyl acetate), polyvinylchloride, poly(vinylchloride-co-methacrylate), polyethylenes, polyolefins, ethylene acrylate ester copolymers, poly(ethylene-co-butyl acrylate), silicone elastomers, epoxy resins, and acid copolymers.

Clause 6: Laminated glazing according to any one of the preceding clauses, wherein the at least one thermoplastic film layer is selected from the group consisting of ethylene vinyl acetate and/or polyvinyl butyral and/or polyethyleneterephthalate.

Clause 7: Laminated glazing according to any one of the preceding clauses, wherein the first and second panes independently have a thickness ranging from 0.5 mm to about 15 mm.

Clause 8: Laminated glazing according to any one of the preceding clauses, wherein the laminate is symmetrical in glass thickness.

Clause 9: Laminated glazing according to any one of the preceding clauses, wherein the laminate is asymmetrical in glass thickness.

Clause 10: Laminated glazing according to any one of the preceding clauses, wherein the at least one thermoplastic film layer is in contact with the topcoat layer based on a mixed nitride of silicon and zirconium of the functional coating.

Clause 11: Laminated glazing according to any one of the preceding clauses, wherein the functional coating comprises n infrared reflective (IR) layers and n+1 dielectric layers, with n≥1, such that each IR layer is surrounded by two dielectric layers.

Clause 12: Laminated glazing according to any one of the preceding clauses, wherein the topcoat layer has a total geometrical thickness of from 0.5 to 22 nm.

Clause 13: Laminated glazing according to any one of the preceding clauses, wherein the topcoat is deposited on and in contact with a layer comprising at least one of silicon nitride, aluminum nitride, mixed nitride of silicon and aluminum, titanium oxide, zirconium oxide, mixed oxide of titanium and zirconium, silicon oxide, aluminum oxide, zinc oxide, tin oxide, mixed oxide of zinc and tin, or a mixture thereof.

Clause 14: Laminated glazing according to any one of the preceding clauses, wherein the topcoat layer based on a mixed nitride of silicon and zirconium may have a minimum atomic Si/Zr ratio of 3.2.

Clause 15: Laminated glazing according to any one of the preceding clauses, wherein the topcoat layer based on a mixed nitride of silicon and zirconium may have a minimum atomic Si/Zr ratio of 5.5.

Clause 16: Laminated glazing according to any one of the preceding clauses, wherein the topcoat layer based on a mixed nitride of silicon and zirconium may have a maximum atomic Si/Zr ratio of 12.0.

Clause 17: A process to provide for a laminated glazing comprising the steps of:
a. providing for a first pane having an inner and an outer surface, and for a second pane having an inner and an outer surface;
b. providing for a functional coating comprising a topcoat layer based on a mixed nitride of silicon and zirconium on one of the inner surface of the first pane or the inner surface of the second pane;
c. providing for a thermoplastic interlayer formed from at least one thermoplastic film layer comprising at least 10% of recycled material;
d. laminating the inner surface of the first pane to the inner surface of the second pane by means of the thermoplastic interlayer to form the laminated glazing.

Clause 18: The process according to clause 17, wherein the functional coating comprising a topcoat layer based on a mixed nitride of silicon and zirconium is provided by a vacuum deposition method.

Clause 19: The process according to clause 17 or clause 18, wherein the topcoat layer based on a mixed nitride of silicon and zirconium is provided by a vacuum deposition method.

Clause 20: Use of a topcoat layer comprising a mixed nitride of silicon and zirconium on a functional coating, to secure adhesion with a thermoplastic film layer comprising at least 10% of recycled material in a laminated glazing.

Clause 21: Use according to clause 20, wherein the functional coating comprises n infrared reflective (IR) layers and n+1 dielectric layers, with n≥1, such that each IR layer is surrounded by two dielectric layers.

Clause 22: Use according to clause 20 or 21, wherein the topcoat is deposited on and in contact with a layer comprising at least one of silicon nitride, aluminum nitride, mixed nitride of silicon and aluminum, titanium oxide, zirconium oxide, mixed oxide of titanium and zirconium, silicon oxide, aluminum oxide, zinc oxide, tin oxide, mixed oxide of zinc and tin, or a mixture thereof.

Clause 23: A glazing comprising a transparent substrate coated with a functional coating, characterized in that the functional coating comprises a topcoat layer based on a mixed nitride of silicon and zirconium having a Si/Zr ratio of from 5.5 to 12.

Clause 24: The glazing according to clause 24, wherein the topcoat layer has a total geometrical thickness layer has a total geometrical thickness of from 0.5 to 22 nm.

Clause 25: The glazing according to clause 23 or 24, wherein the functional coating comprises n infrared reflective (IR) layers and n+1 dielectric layers, with n≥1, such that each IR layer is surrounded by two dielectric layers.

Clause 26: The glazing according to any one of the preceding clauses 23 to 25, wherein the topcoat is deposited on and in contact with a layer comprising at least one of silicon nitride, aluminum nitride, mixed nitride of silicon and aluminum, titanium oxide, zirconium oxide, mixed oxide of titanium and zirconium, silicon oxide, aluminum oxide, zinc oxide, tin oxide, mixed oxide of zinc and tin, or a mixture thereof.

Clause 27: The glazing according to any one of the preceding clauses 23 to 26, wherein the topcoat is deposited on and in contact with a layer comprising at least one of silicon nitride, aluminum nitride, mixed nitride of silicon and aluminum, or a mixture thereof.

Clause 28: The glazing according to any one of the preceding clauses 23 to 27, wherein the glazing has a thickness ranging from 0.5 mm to about 15 mm, alternatively from 0.5 mm to about 10 mm, alternatively from 0.5 mm to about 8 mm, alternatively from 0.5 mm to about 6 mm.

Clause 29: A laminated glazing comprising a first pane having an inner and an outer surface, a second pane having an inner and an outer surface and a thermoplastic interlayer, which connects the inner surface of the first pane to the inner surface of the second pane,
a. wherein the thermoplastic interlayer is formed from at least one thermoplastic film layer comprising at least 10% of recycled material, and
b. wherein at least one of the inner surface of the first pane or the inner surface of the second pane is provided with a functional coating comprising n infrared reflective (IR) layers and n+1 dielectric layers, with n≥1, such that each IR layer is surrounded by two dielectric layers, and comprising a topcoat layer based on a mixed nitride of silicon and zirconium having a Si/Zr ratio of from 5.5 to 12.

### EXAMPLES

### Materials

Thermoplastic film materials were used from Kuraray (GV100AR3???) for recycled polyvinyl butyral, and from Eastman for virgin for fresh/virgin polyvinyl butyral (RC41 ???).

In the following tables:
Ag represents silver
SiN represents a layer of silicon nitride Si₃N₄
TZO is a layer of titanium zirconium mixed oxide, provided from a ceramic target of TiZrOₓ composed of TiOₓ/ZrO₂ with proportions of 65 wt % TiO₂ and 35 wt % ZrO₂ (providing for 74 at % Ti and 26 at % Zr)
ZnO represents a layer of zinc oxide without dopant, provided from a zinc metallic target
ZSO5 represents a layer of zinc-tin mixed provided from a metallic target comprising Zn at 52 wt % and Sn at 48 wt %
Ti represents a layer of titanium, provided from a metallic target

### Test methods

Falling ball tests according to ECE R43 were performed.

In the first test, a steel ball weighing 227 g was dropped onto the outer pane 2 from a height of 8.5 m. This test simulates the impact of a stone on the outside of the laminated glass. The test was considered passed if the ball was stopped by the laminated glass and this was not penetrated and if the amount of splinters on the side facing away from the impact falls below a certain (thickness-dependent) amount.

In the second test, a steel ball weighing 2260 g was dropped onto the inner pane 1 from a height of 4 m. This test simulates the impact of the head of a vehicle occupant on the laminated glass. The test was considered passed if the ball was stopped by the laminated glass and it did not penetrate within 5 seconds after rupture.

Adhesion of thermoplastic interlayers to the glass panes was evaluated by use of the pummel adhesion test (pummel adhesion value has no units). The test included conditioning laminates at −18° C. for a predetermined time followed by pummeling or impacting the samples with a 0.45 kg (1 lb.) hammer to shatter the glass. Adhesion was judged by the amount of exposed interlayer material resulting from glass that has fallen off of the interlayer. All broken glass un-adhered to the interlayer sheet was removed. The glass left adhered to the interlayer sheet was visually compared with a set of standards of known pummel scale. The higher the number, the more glass that remained adhered to the sheet, i.e., a pummel adhesion value of zero means that no glass remained adhered to the interlayer, and a pummel value of 10 means that 100% of the glass remained adhered to the interlayer. To achieve acceptable penetration resistance (or impact strength) for typical glass/interlayer/glass laminates, interfacial glass/interlayer material adhesion levels should be maintained at about 3-7 Pummel units. Acceptable penetration resistance is achieved for typical glass/interlayer/glass laminates at a pummel adhesion value of 3 to 7, preferably 4 to 6. At a pummel adhesion value of less than 2, too much glass is generally lost from the sheet and glass in typical glass/interlayer/glass during impact and problems with laminate integrity (i.e., delamination) and long term durability that can also occur. At a pummel adhesion value of more than 7, adhesion of the glass to the sheet is generally too high in typical glass/interlayer/glass and can result in a laminate with poor energy dissipation and low penetration resistance.

Adhesion of thermoplastic interlayers to the glass panes can be measured by use of Compressive Shear Test (CST). The test consists of laminated glazing samples fixed into a upper and lower metallic fixture. The upper fixture on which a compressive loading is applied (often through a sphere-on-flat arrangement that ensures transmission of vertical forces only), a lower fixture that can translate perpendicular to the loading, direction and a plane-parallel sample consisting of an adhesive layer (PVB, . . . ) laminated in between two glass panes. The sample is oriented at a given angle with respect to the loading direction so that it experiences a combination of both shear and compressive stresses. Force and applied displacement are recorded until failure. At a loading angle of 45°, the compressive stress equals the shear stress.

### Examples 1 and 2 and Comparative Examples 1 to 3

A typical functional coating comprising 1 infrared reflective (IR) layers sandwiched between two dielectric layers was provided as follows, on a first glass pane of clear float glass having a thickness of 2.1 mm:
Glass/SiN (41 nm)/NiCr (1 nm)/Ag (10 nm)/NiCr (1 nm)/SiN (48)/topcoat (16 nm)

The first glass pane was laminated with a second glass pane of clear float glass having a thickness of 2.1 mm by means of a thermoplastic film layer of 0.76 mm.

In Example 1, the topcoat was a layer of mixed nitride of silicon and zirconium having a Si/Zr atomic ratio of 6.0 and the thermoplastic film layer comprised 100% of recycled material.

In Example 2, the topcoat was a layer of mixed nitride of silicon and zirconium having a Si/Zr atomic ratio of 4.6 and the thermoplastic film layer comprised 100% of recycled material.

In Comparative Example 1, the topcoat was a layer of mixed oxide of titanium and zirconium comprising 65 wt % TiO₂ and 35 wt % ZrO₂ and the a thermoplastic film layer comprised 100% of recycled material.

In Comparative Example 2, the topcoat was a layer of mixed oxide of titanium and zirconium 65 wt % TiO₂ and 35 wt % ZrO₂ and the a thermoplastic film layer comprised 100% of virgin material, and thus 0% recycled material.

In Comparative Example 3, the topcoat was a layer of mixed nitride of silicon and zirconium having a Si/Zr atomic ratio of 6.0 and the a thermoplastic film layer comprised 100% of virgin material, and thus 0% recycled material

From the big and small ball drop tests and Pummel test carried out as explained above, it was clearly evidenced that the topcoat layer of mixed nitride of silicon and zirconium provides for improved compatibility and thus adhesion to the thermoplastic film layer, as compared to a layer of mixed oxide of titanium and zirconium, towards a thermoplastic film layer comprising at least 10% recycled material. The laminated glass is thus characterized by a high resistance to breakage. Comparative example 1 demonstrated a coating/thermoplastic film layer interface adhesive failure, such that the big ball drop test was not passed. Indeed, due to the impact, the big ball penetrated through the laminated glazing, which is not acceptable in view of European Automotive R43 regulation for automotive.

When the thermoplastic film layer comprises no recycled material, the topcoat layer of mixed nitride of silicon and zirconium provides for equivalent compatibility to a topcoat layer of mixed oxide of titanium and zirconium comprising 65 wt % TiO2 and 35 wt % ZrO2.

| Topcoat | | | Comparative | Comparative | Comparative |
|---|---|---|---|---|---|
| type | Example 1 | Example 2 | Example 1 | Example 2 | Example 3 |
| Topcoat | SiZrN | SiZrN | TZO | TZO | SiZrN |
| PVB | Recycled | Recycled | Recycled | Virgin | Virgin |
| Small | OK | OK | OK | OK | OK |
| ball drop | | | | | |
| Big | OK | OK | KO | OK | OK |
| ball drop | | | | | |
| Pummel | OK | OK | OK | OK | OK |

EXAMPLE 3 and COMPARATIVE EXAMPLE 4

A typical functional coating comprising 2 infrared reflective (IR) layers sandwiched

between three dielectric layers was provided as follows, on a first glass pane of clear float glass having a thickness of 2.1 mm:

| | ZSO5 | ZnO | Ag | Ti | ZSO5 | ZnO | Ag | Ti | ZSO5 | Topcoat |
|---|---|---|---|---|---|---|---|---|---|---|
| nm | 20 | 8 | 10 | 5 | 70 | 8 | 10 | 5 | 20 | 6 |

The first glass pane was laminated with a second glass pane of clear float glass having a thickness of 2.1 mm by means of a thermoplastic film layer of 0.76 mm.

In Example 3, the topcoat was a layer of mixed nitride of silicon and zirconium having a Si/Zr atomic ratio of 6.0 and the a thermoplastic film layer comprised 100% of recycled material.

In Comparative Example 4, the topcoat was a layer of mixed oxide of titanium and zirconium comprising 65 wt % TiO2 and 35 wt % ZrO2 and the a thermoplastic film layer comprised 100% of recycled material.

From the big and small ball drop tests and Pummel test carried out as explained above, it was clearly evidenced that the topcoat layer of mixed nitride of silicon and zirconium provides for improved compatibility and thus adhesion to the thermoplastic film layer, as compared to a layer of mixed oxide of titanium and zirconium, towards a thermoplastic film layer comprising at least 10% recycled material.

Comparative example 4 demonstrated a coating/thermoplastic film layer interface adhesive failure, such that the big ball drop test was not passed. Indeed, as for Comparative example 1, due to the impact, the big ball penetrated through the laminated glazing, which is not acceptable in view of European Automotive R43 regulation for automotive.

| Topcoat | | Comparative |
|---|---|---|
| type | Example 3 | Example 4 |
| Topcoat | SiZrN | TZO |
| PVB | Recycled | Recycled |
| Small | OK | OK |
| ball drop | | |
| Big | OK | KO |
| ball drop | | |
| Pummel | OK | OK |

1. A laminated glazing, comprising:
a first pane having an inner and an outer surface;
a second pane having an inner and an outer surface; and
a thermoplastic interlayer,
wherein the thermoplastic interlayer connects the inner surface of the first pane to the inner surface of the second pane,
wherein the thermoplastic interlayer is formed from at least one thermoplastic film layer comprising at least 10% of recycled material, and
wherein at least one of the inner surface of the first pane or the inner surface of the second pane is provided with a functional coating comprising a topcoat layer based on a mixed nitride of silicon and zirconium.

2. The laminated glazing according to claim 1, wherein the at least one thermoplastic interlayer comprises at least 20% of recycled material.

3. The laminated glazing according to claim 1, wherein the thermoplastic interlayer is a thermoplastic film layer comprising at least 10% of recycled material.

4. The laminated glazing according to claim 3, wherein the at least one thermoplastic film layer is selected from polyvinyl acetal, polyvinyl butyral, polyurethane, poly(ethylene-co-vinyl acetate), polyvinylchloride, poly(vinylchloride-co-methacrylate), polyethylenes, polyolefins, ethylene acrylate ester copolymers, poly(ethylene-co-butyl acrylate), silicone elastomers, epoxy resins, and acid copolymers.

5. The laminated glazing according to claim 3, wherein the at least one thermoplastic film layer is in contact with the topcoat layer based on a mixed nitride of silicon and zirconium of the functional coating.

6. The laminated glazing according to claim 1, wherein the functional coating comprises n infrared reflective (IR) layers and n+1 dielectric layers, with n≥1, such that each IR layer is surrounded by two dielectric layers.

7. The laminated glazing according to claim 1, wherein the topcoat layer has a total geometrical thickness of from 0.5 to 22 nm.

8. The laminated glazing according to claim 1, wherein the topcoat layer is deposited on and in contact with a layer comprising at least one of silicon nitride, aluminum nitride, mixed nitride of silicon and aluminum, titanium oxide, zirconium oxide, mixed oxide of titanium and zirconium, silicon oxide, aluminum oxide, zinc oxide, tin oxide, mixed oxide of zinc and tin, or a mixture thereof.

9. The laminated glazing according to claim 1, wherein the topcoat layer based on a mixed nitride of silicon and zirconium has a minimum atomic Si/Zr ratio of 3.2.

10. The laminated glazing according to claim 1, wherein the topcoat layer based on a mixed nitride of silicon and zirconium has a maximum atomic Si/Zr ratio of 12.0.

11. A process of providing a laminated glazing, comprising:
providing a first pane having an inner and an outer surface, and a second pane having an inner and an outer surface;
providing a functional coating comprising a topcoat layer based on a mixed nitride of silicon and zirconium on one of the inner surface of the first pane or the inner surface of the second pane;
providing a thermoplastic interlayer formed from at least one thermoplastic film layer comprising at least 10% of recycled material; and
laminating the inner surface of the first pane to the inner surface of the second pane by means of the thermoplastic interlayer to form the laminated glazing.

12. The process according to claim 11, wherein the functional coating comprising a topcoat layer based on a mixed nitride of silicon and zirconium is provided by a vacuum deposition method.

13. A method, comprising:
applying a topcoat layer comprising a mixed nitride of silicon and zirconium on a functional coating, to secure adhesion with a thermoplastic film layer comprising at least 10% of recycled material in a laminated glazing.

14. The method according to claim 13, wherein the functional coating comprises n infrared reflective (IR) layers and n+1 dielectric layers, with n≥1, such that each IR layer is surrounded by two dielectric layers.

15. The method according to claim 13, wherein the topcoat layer is deposited on and in contact with a layer comprising at least one of silicon nitride, aluminum nitride, mixed nitride of silicon and aluminum, titanium oxide, zirconium oxide, mixed oxide of titanium and zirconium, silicon oxide, aluminum oxide, zinc oxide, tin oxide, mixed oxide of zinc and tin, or a mixture thereof.

16. The laminated glazing according to claim 1, wherein the at least one thermoplastic interlayer comprises at least 60% of recycled material.

17. The laminated glazing according to claim 1, wherein the at least one thermoplastic interlayer comprises 100% of recycled material.
